(19) United States
(12) Patent Application Publication
(10) Pub. No.: US 2025/0083984 A1
(43) Pub. Date: Mar. 13, 2025

(54) WATER TREATMENT SYSTEM VALVE BODY

(71) Applicant: Franklin Electric Co., Inc., Fort Wayne, IN (US)

(72) Inventors: Zachary G. Lightner, Fort Wayne, IN (US); Robert D. Rohr, LaOtto, IN (US); Jose Gabriel Davila Rangel, Fort Wayne, IN (US)

(21) Appl. No.: 18/243,940

(22) Filed: Sep. 8, 2023

(51) Int. Cl. C02F 5/08

(52) U.S. Cl. CPC C02F 5/08; C02F 2201/005; C02F 2301/04; C02F 2303/16

(57) ABSTRACT

A valve body for a water softener system includes a controller, a seal assembly, and a reciprocating piston driven by a drive mechanism. The controller sends signals to the drive mechanism which moves the piston into various positions. The piston cooperates with the seal assembly to direct the flow of liquid through various flow paths, allowing for water softening and regeneration. During regeneration, a regenerant mixture is directed to flow through a resin bed. The valve body is configurable to perform the regeneration process either through a down-flow configuration, wherein a removable filter is coupled to the valve body in a first orientation and a removable brine injector is installed in a first orifice in the valve body or through an up-flow configuration wherein the removable filter is in a second orientation and the removable brine injector is installed in a second orifice.

### BACKGROUND

### Technical Field

The present disclosure relates to water treatment system valve bodies and, in particular, to a valve body that allows a water treatment system to be selectively configured for either up-flow regeneration or down-flow regeneration.

### Description of the Related Art

Water softeners systems are commonly used to remove undesirable minerals (such as calcium, magnesium, manganese, and iron) from mineral-rich, or “hard” water. These systems may employ an ion exchange process to attract these undesirable minerals to other materials, such as salts, to deliver treated or “soft” water to the end user. Such ion exchange may be accomplished by providing an ion exchange resin bed containing resin materials designed to promote the ion exchange process. The resin bed is housed in a tank filled with an untreated water source, and as this untreated water passes through the resin bed, the negatively charged resin (carboxylates) either attracts the positively charged minerals (Ca, Mg) or the positively charged sodium or potassium ions from the brine solution.

Ion exchange resin capacity is gradually depleted as the ion exchange process is repeated over time. Water treatment controls may be provided as part of a water softener system to periodically regenerate the resin contained in the tank. This regeneration can be accomplished, for example, by the reversal of the above-described softening process. That is, the undesirable ions formerly bonded to the resin during the water softening process (such as calcium) are chemically replaced with sodium or similar ions. In some systems, this reversal is accomplished by passing a regenerant solution of sodium or potassium chloride through the resin bed.

The regeneration process may include a number of cycles, including a backwash cycle to remove turbidity from the resin bed, a brine draw cycle to introduce the regenerant to the resin bed, a rinse cycle to settle the resin after the backwash and brine draw cycles and remove excess sodium or potassium from the resin tank after resin regeneration, and a brine refill cycle to prepare a brine solution for the next regeneration. To effect distribution of the regenerant solution, a control valve may be attached to the top of the tank. The control valve includes a structure for directing the flow of fluid to complete the regeneration process, such as a reciprocating piston, rotating disc or poppets.

Reciprocating piston type water treatment control valves generally have a seal arrangement contained within a cylindrical bore and surrounding a piston. In these types of arrangements, a motor may drive the piston axially to selectively connect particular inlet and outlet ports, thereby cycling the valve through various positions involved in the regeneration process. The piston moves to connect ports in various combinations, as the respective seals provide a watertight barrier between ports. The piston may be one solid piece, or may be separate individual pieces joined together.

Typical water softeners perform the brine draw cycle of regeneration either only in an up-flow configuration or only in a down-flow configuration. The difference between both configurations has to do with the direction in which the brine solution and inlet water flow through the resin bed during regeneration. In an up-flow configuration, the mixture flows to the bottom of the tank through a distributor tube and is forced upwards through the bottom of the resin bed and out of the top of the resin bed. This is aided by the rounded tank bottom and, in some applications, a radial flow basket that causes the downward flowing mixture to spiral upwards. In a down-flow configuration, the water-brine solution mixture flows down through the top of the resin bed (outside the distributor tube) and out of the bottom of the resin bed up through the distributor tube.

As the system operates, the negatively charged resin beads attract the positively charged sodium or potassium ions from the brine solution. Over time, the concentration of the brine solution will diminish and will need to be restored to continue softening hard water. Typically, the brine solution is located in a brine storage tank with a user-accessible interior cavity, such that the user can periodically refill the storage tank with additional water softening salt/potassium as the brine concentration level drops.

### SUMMARY

The present disclosure provides a valve body for a water treatment system that allows the water treatment system to selectively perform regeneration in either an up-flow configuration or in a down-flow configuration.

A valve body for a water softener system includes a controller, a seal assembly, and a reciprocating piston driven by a drive mechanism. The controller sends signals to the drive mechanism which moves the piston into various positions. The piston cooperates with the seal assembly to direct the flow of liquid through various flow paths, allowing for water softening and regeneration. During regeneration, a regenerant mixture is directed to flow through a resin bed, and sodium or potassium ions from the regenerant will be attracted to the negatively charged resin in the resin bed. The regeneration process can occur either through an up-flow configuration or through a down-flow configuration. The valve body of the present disclosure allows for a water softener system to perform regeneration in an up-flow configuration or a down-flow configuration simply by switching positions of a removable brine injector and a removable plug, and reorienting a removable filter.

A water softening system may include a softening tank having a resin bed, a hard-water inlet port, an outlet port, a drain port, and a brine port. In some embodiments, the water softening system may also include a control module fluidly coupled to the softening tank. In some embodiments, the control module may include an elongated bore including one or more internal ports at spaced apart locations. In some embodiments, the water softening system may also include a piston slidably mounted in the elongated bore. In some embodiments, the piston may have recesses formed at spaced apart locations creating annular flow paths around the piston.

In some embodiments, the water softening system may also include a regeneration flow path direction control assembly which allows the controller to create a first regeneration flow path where regenerant flows in through the top of the resin bed and out through the bottom of the resin bed. In some embodiments, the water softening system may also include a second regeneration flow path where regenerant flows in through the bottom resin bed and out through the top of the resin bed. In some embodiments, the regeneration flow path direction control assembly may include a treatment sump, a removable filter fluidly coupled to the treatment sump, and a removable brine injector fluidly coupled to the treatment sump.

In some embodiments, the user may create a second regeneration flow path by switching the positions of the removable brine injector and the removable plug, and reorienting the removable filter. In some embodiments, the water softening system may also include a drive mechanism operably coupled to the piston and a controller operably coupled to the drive mechanism. In some embodiments, the drive mechanism may be an electric motor. In some embodiments, the water softening system may also include a seal assembly disposed between the piston and the elongated bore. In some embodiments, the water softening system may also include a plurality of spacer rings and a plurality of sealing rings arranged along the elongated bore such that the seal assembly and the piston cooperate to selectively allow liquid from the one or more internal ports of the elongated bore to flow through the spacer rings and through the annular flow paths formed by the recesses on the piston.

In some embodiments, the controller may position the piston to selectively allow liquid to flow from the hard-water inlet port, through the resin bed, and to the outlet port through the annular flow paths between the piston and the seal assembly during normal operation. In some embodiments, the water softening system may also include a distributor tube fluidly coupled to the elongated bore on a first end and fluidly coupled to the resin tank on an opposite second end, such that untreated water from the control valve flows from the control valve to the bottom of the resin tank, bypassing the resin bed. In some embodiments, the regenerant may be a brine solution. In some embodiments, the water softening system may also include a first orifice for the removable filter to be installed, a removable plug, and a second orifice for the removable plug to be installed.

In some embodiments, the controller may create a second regeneration flow path by installing the removable plug in the first orifice and installing the removable filter in the second orifice. In some embodiments, the water softening system may automatically detect a change in orientation of the removable filter and automatically adjusts the controller outputs to the piston. In some embodiments, the water softening system may also include may automatically detect a change in position of the removable brine injector and automatically adjusts the controller outputs to the piston. In some embodiments, the water softening system may automatically detect a change in position of the removable plug and automatically adjusts the controller outputs to the piston.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic view of a water treatment system, in accordance with the present disclosure;

FIG. 2A is a perspective view of a water treatment system valve body, showing a removable filter, removable brine injector, and a removable plug in an up-flow configuration;

FIG. 2B is a perspective view of a water treatment system valve body, showing the removable filter, the removable brine injector, and the removable plug in a down-flow configuration;

FIG. 3 is a perspective view of a water treatment system valve body, showing a control module;

FIG. 4 is a cross-section view of the water treatment system valve body, showing the flow paths formed by the piston and seal assembly in the service position;

FIG. 5 is a cross-section view of the water treatment system valve body, showing the flow paths formed by the piston and seal assembly during the rinse cycle of regeneration;

FIG. 6 is a cross-section view of the water treatment system valve body, showing the flow paths formed by the piston and seal assembly during the backwash cycle of regeneration;

FIG. 7 is a cross-section view of the water treatment system valve body, showing the flow paths formed by the piston and seal assembly during the brine draw cycle of down-flow regeneration;

FIG. 8 is a cross-section view of the water treatment system valve body, showing the flow paths formed by the piston and seal assembly during the brine draw cycle of up-flow regeneration; and

FIG. 9 is a cross-section view of the water treatment system valve body, showing the flow paths formed by the piston and seal assembly during the brine fill cycle of regeneration.

Corresponding reference characters indicate corresponding parts throughout the several views. Unless stated otherwise the drawings are proportional and drawn to scale.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings.

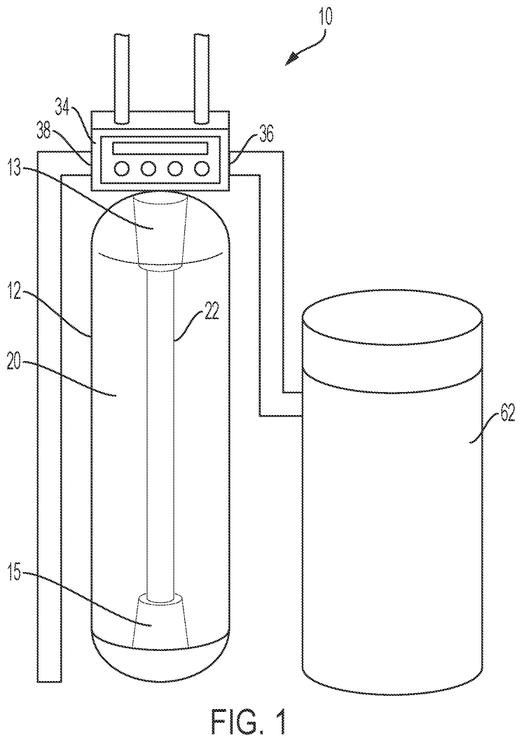

For purposes of the present disclosure, directionality will be referenced in the context of a typical use of a water softening system, such as system 10 shown in FIG. 1. Thus, an “upper” or “top” feature is considered to be vertically above a “lower” or “bottom” feature as viewed in a typical water softener installation.

Although water softener system 10 is used herein to illustrate aspects of the present disclosure, other applications are envisioned. For example, some water softening systems and control units utilize multiple tanks. These tanks can be identical such that a controller, such as controller 32 described below, can switch between tanks such that softened water will always be available while the other tank regenerates. Another application for twin-tank control units is to have one tank operate as a dedicated filter for applications with very high amounts of insoluble solids and materials in the water. One such example is an iron filter, which is used in installations with incoming water with high iron content. For filtration, the tank setup can be the same as resin tank 12 described below, except the water softening resin is replaced with filter media.

Referring to FIG. 1, an exemplary water softener system 10 is shown. Water softener system 10 includes a resin tank 12 containing a resin bed 20, a distributor tube 22, an upper distributor basket 13 and a lower distributor basket 15. In certain embodiments, the distributor baskets 13, 15 may be as described in U.S. Patent Application Ser./N 63/476,540, entitled “Water Treatment Distributor,” filed on Dec. 21, 2022, the entire contents of which being expressly incorporated herein by reference. Distributor tube 22 spans the length of resin tank 12 and is able to deliver fluid to the bottom of resin tank 12 bypassing resin bed 20. Water softener system 10 further includes motor-actuated valve 34 fluidly connected to distributor tube 22 and to brine tank 62.

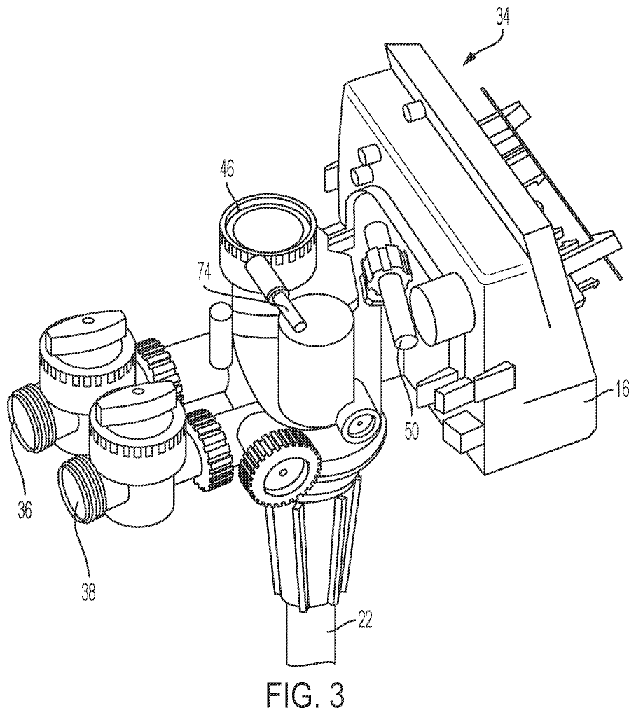

Referring to FIG. 3, motor-actuated valve 34 includes fluid inlet 36, fluid outlet 38, drain 50, injector assembly 46, and a brine port 74, all fluidly connected to each other. In the illustrated embodiment of FIG. 3, fluid inlet 36 receives a flow fluid to be treated, and fluid outlet 38 discharges a flow of treated fluid after such fluid has been operated upon as described in further detail below. As is further described below, drain 50 may be fluidly connected to internal ports 80, 82, 84, 86 during certain regeneration operations and closed off during others, such as service and brine fill. Injector assembly 46 is fluidly connected to fluid inlet 36.

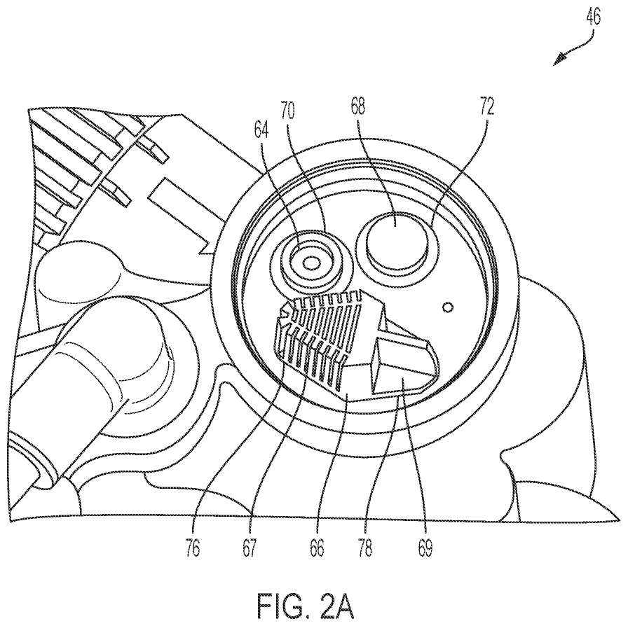

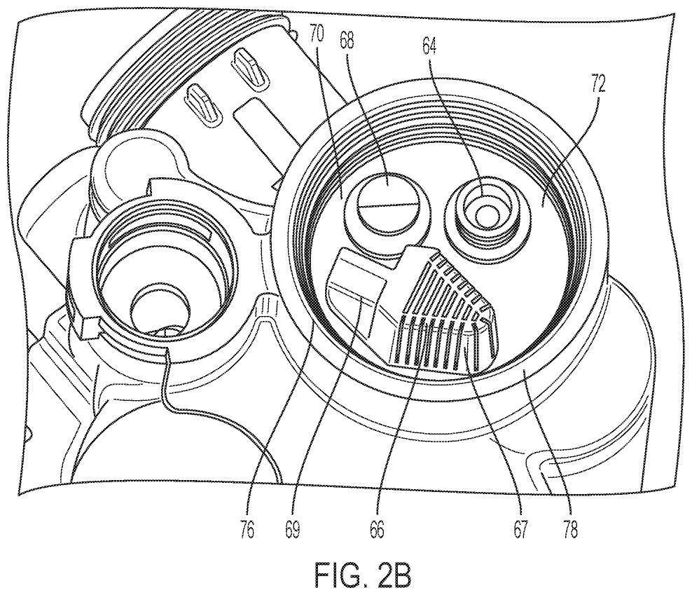

As shown in FIG. 2A, injector assembly 46 includes removable brine injector 64, shown installed in first orifice 70, removable plug 68 shown installed in second orifice 72, and removable filter 66. Removable filter 66 includes screen portion 67 shown installed in third orifice 76 and lug portion 69 shown installed in fourth orifice 78. As shown in FIGS. 2A-2B, screen portion 67 and lug portion 69 are formed as a one-piece filter. In other embodiments, screen portion 67 and lug portion 69 may be two separate pieces which together form removable filter 66. Each of removable brine injector 64, removable plug 68, and removable filter 66 can be easily detached from motor-actuated valve 34. The positions of removable brine injector 64 and removable plug 68 can be switched between first orifice 70 and second orifice 72, and the orientation of removable filter 66 can be reversed. Changing the positions and orientation of removable brine injector 64, removable plug 68, and removable filter 66 allows for water softener system 10 to perform regeneration in an up-flow (corresponding to the positions and orientation depicted in FIG. 2A) or down-flow configuration (corresponding to the positions and orientations depicted in FIG. 2B).

As fluid enters motor-actuated valve 34 through fluid inlet 36, a vacuum pressure is created which selectively draws a brine solution from brine tank 62 via injector assembly 46. During regeneration, removable brine injector 64 creates a vacuum, through the venturi effect, and brine solution is drawn from brine tank 62. The brine solution mixes with fluid entering fluid inlet 36 and, after being used to regenerate resin bed 20, exits through drain 50. During regular operation of water softener system 10, most of the fluid that enters motor-actuated valve 34 through fluid inlet 36 is directed through the resin bed 20 to be softened and a portion of the inlet fluid may pass through removable filter 66. After flowing through the resin bed 20, the treated water exits motor-actuated valve 34 through fluid outlet 38 for delivery to the home or other building.

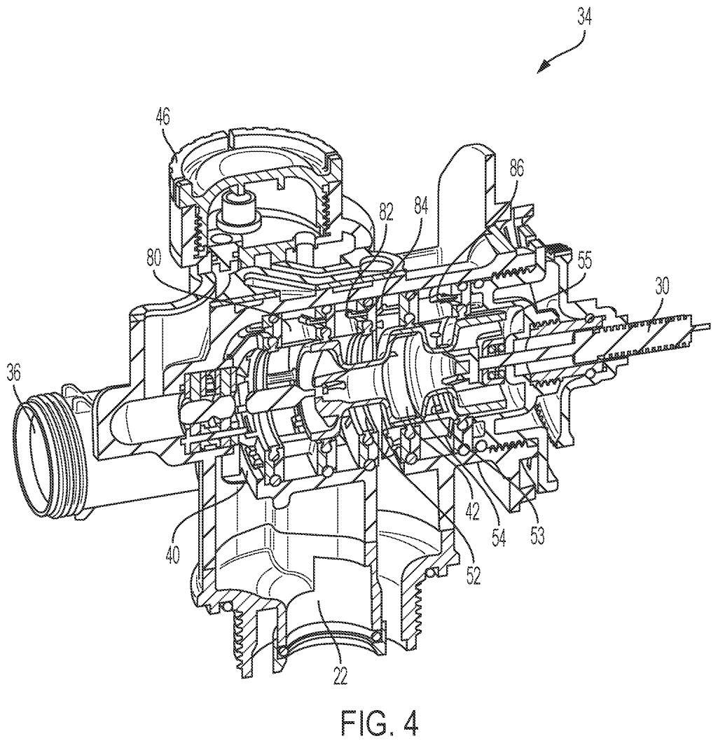

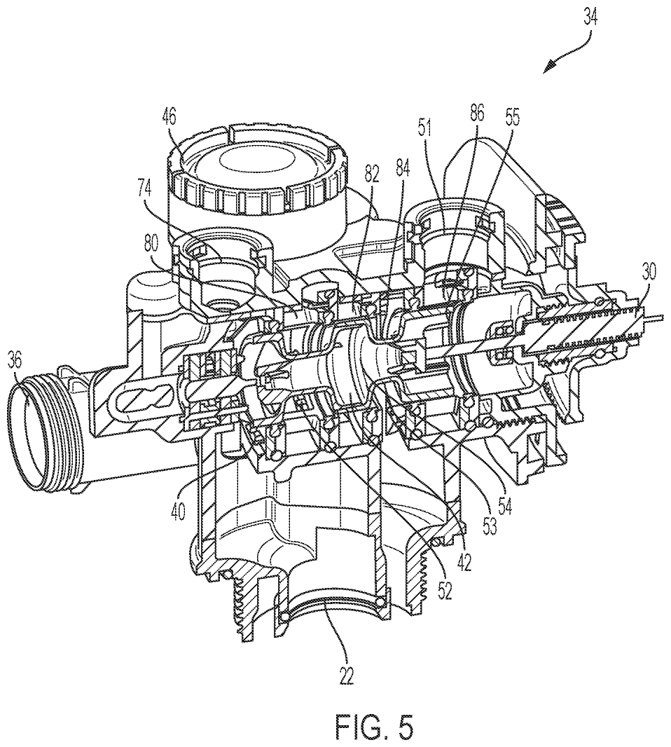

As shown in FIGS. 4 and 5, motor-actuated valve 34 further includes piston 42 slidably mounted in elongated bore 40 and operably connected to control module 16 (FIG. 3). Control module 16 includes arm 30 operably connected on a first end to motor 28 (not labeled) and operably connected on an opposite, second end to controller 32. Controller 32 actuates arm 30 to move piston 42 axially into different positions within elongated bore 40. In an exemplary embodiment, such movement of piston 42 is controlled according to various inputs into controller 32 also contained within control module 16, which may receive signals from other parts of the system or the user. Piston 42 further includes central cavity 54 running through the longitudinal axis of piston 42 and annular recesses 52 and 53 on the outer circumference of piston 42. Central cavity 54 forms a passageway for fluid to pass through piston 42 from one end to the other, while annular recesses 52 and 53 allow fluid to flow around piston 42 depending upon the position of piston 42 relative to seal assembly 44 described below.

Seal assembly 44 is disposed between piston 42 and the adjacent wall of elongated bore 40 to selectively seal ports 80, 82, 84, 86 from one another depending on the position of piston 42. Depending on the position of piston 42 disposed within elongated bore 40, annular recesses 52 and 53 formed in piston 42 align with one or more of the annular flow paths defined by ports 80, 82, 84, 86 within elongated bore 40 to allow fluid to flow therethrough.

In the illustrated embodiment, water softener system 10 has one service position and four regeneration cycles namely rinse, backwash, brine draw, and brine fill. Additionally, water softener system 10 can perform regeneration in an up-flow configuration and in a down-flow configuration. In the backwash cycle, water is directed to the bottom of the resin tank 12 and through the resin bed 20, and removes turbidity by flowing through the motor-actuated valve 34 and to drain 50.

In the service position, when softened water is required, untreated pressurized water flows into motor-actuated valve 34 through fluid inlet 36 and around distributor tube 22 to the top of resin tank 12, as illustrated in FIG. 4. The untreated water flows down through the resin bed 20 and reaches the rounded bottom of resin tank 12 where it then flow upwardly through distributor tube 22, through motor-actuated valve 34 out fluid outlet 38 to a final delivery point as softened water.

During the rinse cycle, cavity exit 55 of piston 42 is aligned with internal port 86, creating a fluid path to drain 50, as shown in FIG. 5. Untreated water enters motor-actuated valve 34 via fluid inlet 36 and flows downwardly to the top of resin tank 12. This helps to settle the resin in resin bed 20. The untreated water then flows upwardly through distributor tube 22 and axially through central cavity 54. The untreated water reaches cavity exit 55, aligned with internal port 86, where it exits motor-actuated valve 34 through drain port 51 and drain 50.

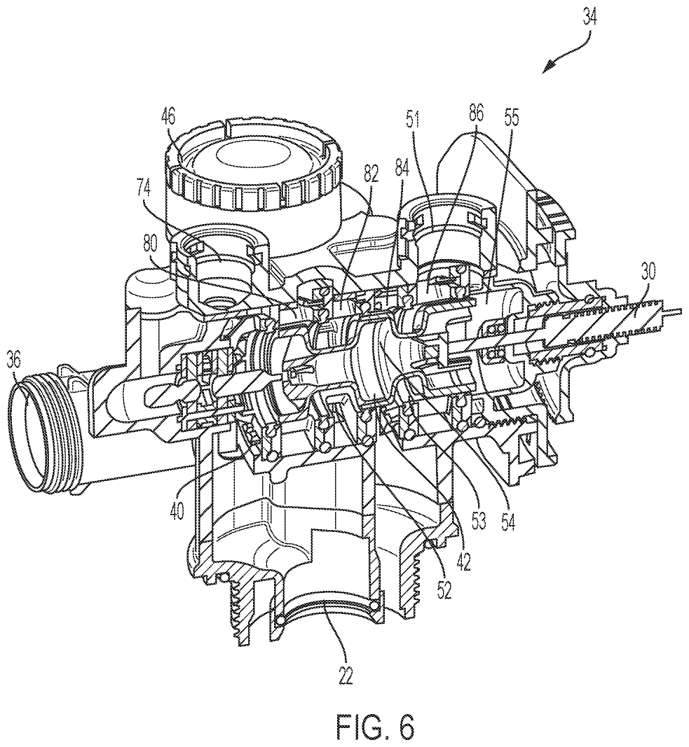

During the backwash cycle, annular recess 53 of piston 42 is aligned with internal port 86, creating a fluid path to drain 50, as shown in FIG. 6. Untreated water enters motor-actuated valve 34 via fluid inlet 36 and flows downwardly through distributor tube 22 and the lower distributor basket 15 to the bottom of resin tank 12. The untreated water reaches the rounded bottom of resin tank 12 and flows upwardly through resin bed 20. This affords an opportunity to dislodge foreign materials lodged within the substrate contained at the bottom of resin tank 12. The resultant waste water then flows upwardly through resin tank 12 and out of motor-actuated valve 34 through drain port 51 and drain 50.

Motor-actuated valve 34 allows water softener system 10 to perform regeneration in either a down-flow configuration or an up-flow configuration by changing the positions of removable filter 66, removable plug 68, and removable brine injector 64. In one embodiment, switching between the up-flow and down-flow configurations entails manually changing the orientation of removable filter 66, and the positions of removable brine injector 64, and removable plug 68. To change the orientation of removable brine injector 64 and removable plug 68, removable brine injector 64 is removed from first orifice 70 and removable plug 68 is removed from second orifice 72. Once removed, removable brine injector 64 is inserted into second orifice 72 and removable plug 68 is inserted into first orifice 70. To change the orientation of removable filter 66, lug portion 69 is removed from fourth orifice 78. Once removed, lug portion 69 is inserted into third orifice 76 and screen portion 67 is positioned over fourth orifice 78, thereby changing the orientation of removable filter 66. Once this modification is made, water softener system 10 performs the brine draw operation in the configuration (down-flow or up-flow) corresponding to the positions of removable filter 66, removable brine injector 64, and removable plug 68.

It is contemplated within the scope of this disclosure that in some embodiments, changing positions of removable plug 68 and removable brine injector 64 between first orifice 70 and second orifice 72 and a changed orientation of removable filter 66 may be detected automatically. In some embodiments, control module 16 may automatically detect that the parts have been changed and adjusts the actuation of arm 30 to axially advance or retract piston 42 within elongated bore 40. In other embodiments, a user provides input signaling the change in configuration using a user interface operably connected to the controller.

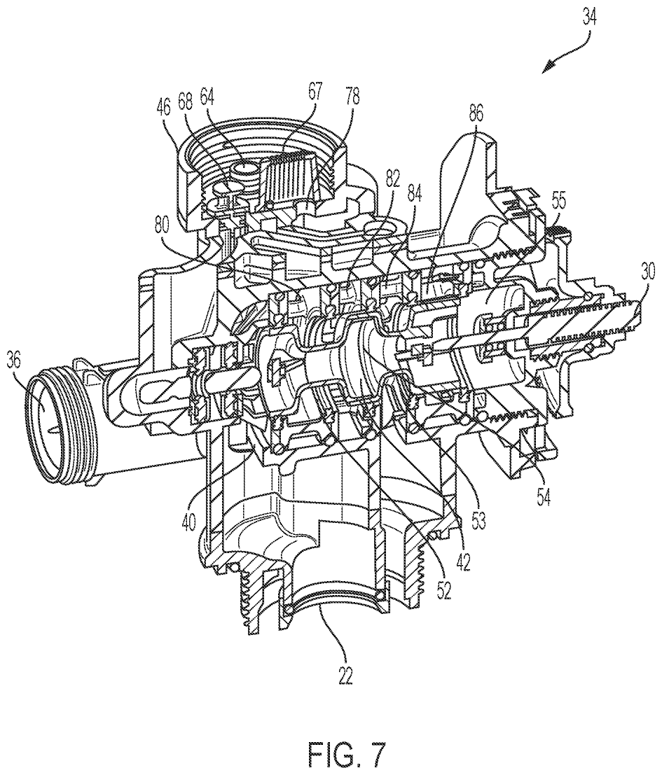

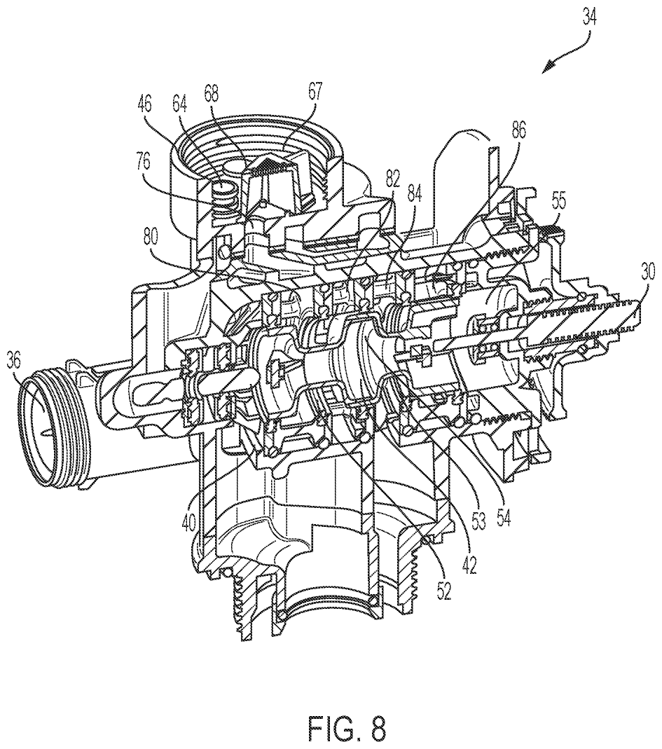

In the down-flow configuration, annular recess 53 of piston 42 is aligned with internal port 84 creating a fluid path to injector assembly 46, as shown in FIG. 7. Cavity exit 55 also aligns with internal port 86 to create a fluid path to drain 50. Removable brine injector 64 is installed in second orifice 72 and removable plug 68 is installed in first orifice 70. Also, screen portion 67 of removable filter 66 is positioned over fourth orifice 78 and lug portion 69 is inserted into third orifice 76 (not shown in FIG. 7). Untreated water is supplied to motor-actuated valve 42 via fluid inlet 36 and passes through removable filter 66 via internal port 82 and fourth orifice 78, which filters out large particles. In this configuration, water flows into injector assembly 46 through fourth orifice 78, and flows out of injector assembly 46 through second orifice 72. Water is prevented from flowing through first orifice 70 and third orifice 76 which are blocked by removable plug 68 and lug portion 69, respectively. The filtered untreated water then flows through removable brine injector 64 and downwardly to the top of resin tank 12. As water flows through removable brine injector 64, a vacuum pressure is created which draws a brine solution from brine tank 62 through brine inlet 74 (FIG. 3). The brine solution mixes with the inlet water and is directed through the upper distributor basket 13 to the top of resin bed 20. As the brine solution flows through resin bed 20, its sodium or potassium ions are exchanged for the hardness mineral ions in the resin. The mineral-rich brine solution then flows up through distributor tube 22 to central cavity 54 of piston 42. The brine solution flows axially within central cavity 54 and flows out of motor-actuated valve 34 through drain port 51 and drain 50. In the up-flow configuration, annular recess 52 of piston 42 is aligned with internal port 82 creating a fluid path to injector assembly 46, as shown in FIG. 8. Annular recess 53 of piston 42 also aligns with internal ports 84 and 86 to create a fluid path to drain 50. The orientation of removable filter 66 is reversed and the positions of removable brine injector 64 and removable plug 68 are switched. Removable brine injector 64 is installed in first orifice 70 and removable plug 68 is installed in second orifice 72. In this configuration, water flows into injector assembly 46 through third orifice 76, and flows out of injector assembly 46 through first orifice 70. Water is prevented from flowing through second orifice 72 and fourth orifice 74 which are blocked by removable plug 68 and lug portion 69, respectively.

In this configuration, the brine draw follows the same process as in the down-flow configuration but flows in the opposite direction. Untreated water is supplied to motor-actuated valve 42 via fluid inlet 36 and flows upwardly around annular recess 52 of piston 42 to injector assembly 46 via internal port 82. The untreated water flows through removable filter 66 then through removable brine injector 64. As water flows through removable brine injector 64, a vacuum pressure is created which draws a brine solution from brine tank 62 through brine inlet 74. The brine solution mixes with the inlet water and is directed through distributor tube 22 and the lower distributor basket 15 to the bottom of resin tank 12. The mixture reaches the rounded bottom of resin tank 12 and spirals upwardly through resin bed 20. Similar to the down-flow configuration, as the brine solution flows through resin bed 20, its sodium or potassium ions are exchanged for the hardness mineral ions in the resin. The brine solution then flows upwardly through tank 12 and out of motor-actuated valve 34 through drain port 51 and drain 50.

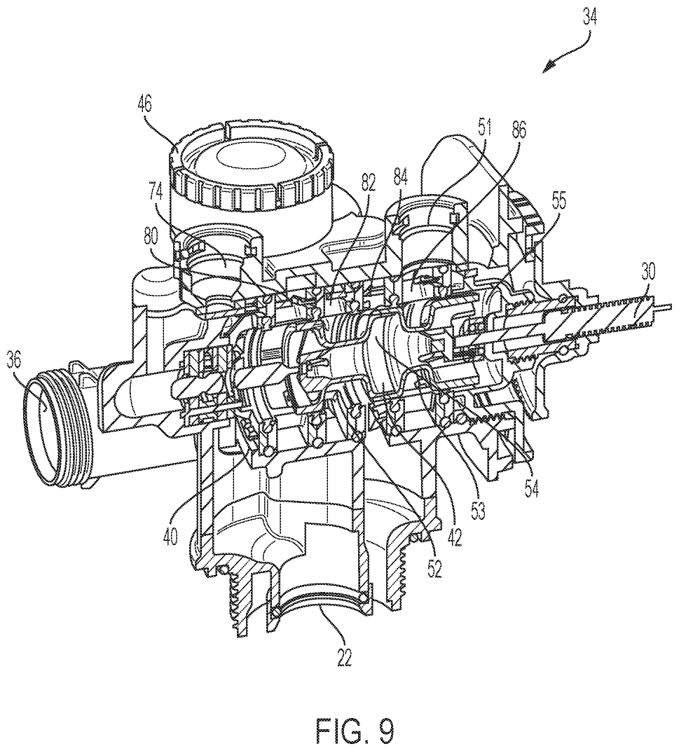

To configure the motor-actuated valve 34 for the brine fill cycle, the controller 32 causes piston 42 to move axially within elongated bore 40 to align annular recess 52 with internal port 82, as shown in FIG. 9. Accordingly, fluid entering fluid inlet 36 flows around piston 42 within annular recess 52 and downwardly to resin tank 12 outside distributor tube 22 to be treated. The treated water then moves upward through distributor tube 22. A portion of the flow of treated water flows around piston 42 through internal port 80 to fluid outlet 38. Another portion of the treated water flows around annular recess 52 of piston 42 within elongated bore 40 and upwardly through brine inlet 74 to brine tank 62 to mix with salt in the brine tank 62 to replenish the brine solution used during regeneration.

To effectively regenerate the resin bed 20 contained in resin tank 12, water softener system 10 may include motor-actuated valve 34 to perform regeneration in either the up-flow or down-flow configurations.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A water softening system comprising:
a softening tank including a resin bed, a hard-water inlet port, an outlet port, and a drain port;
a control valve fluidly coupled to the softening tank, the control valve comprising:
a seal assembly disposed within an elongated bore and defining one or more internal ports at spaced apart locations;
a piston slidably mounted in the elongated bore, the piston having recesses formed at spaced apart locations that create annular flow paths around the piston when aligned with the one or more internal ports;
and
a regeneration flow path direction control assembly which allows the control valve to create a first regeneration flow path where regenerant flows around a distributor tube in through a top of the resin bed and out through the distributor tube from a bottom of the resin bed and a second regeneration flow path where regenerant flows through the distributor tube to the bottom of the resin bed and out around the distributor tube.

2. The water softening system of claim 1, wherein the regeneration flow path direction control assembly further comprises:
a removable filter configured to be coupled to the control valve in either a first orientation or a second orientation;
a removable brine injector configured to be installed on the control valve in either a first orifice or a second orifice; and
a removable plug configured to be installed on the control valve in either the first orifice or the second orifice.

3. The water softening system of claim 2, wherein the control valve creates the first regeneration flow path when the removable filter is in the first orientation, the removable brine injector is installed in the first orifice, and the removable plug is installed in the second orifice, and the second regeneration flow path when the removable filter is in the second orientation, the removable brine injector is installed in the second orifice, and the removable plug is installed in the first orifice.

4. The water softening system of claim 1, further comprising a drive mechanism operably coupled to the piston and a controller operably coupled to the drive mechanism.

5. The water softening system of claim 4, wherein the drive mechanism is an electric motor.

6. The water softening system of claim 4, wherein during regular operation, the controller positions the piston to selectively allow liquid to flow from the hard-water inlet port, through the resin bed, and to the outlet port through the annular flow paths between the piston and the seal assembly.

7. The water softening system of claim 1, wherein the distributor tube includes a first end fluidly coupled to the elongated bore and a second, opposite end fluidly coupled to the softening tank such that untreated water from the control valve flows in the second regeneration flow path from the control valve through the distributor tube to the bottom of the softening tank, bypassing the resin bed.

8. The water softening system of claim 1, wherein the regenerant is a brine solution.

10. The water softening system of claim 3, wherein the water softening system automatically detects the orientation of the removable filter and the positions of the removable brine injector and the removable plug, and automatically adjusts a position of the piston according to the detected orientation and positions.

11. A control valve assembly for a water treatment system having a softening tank including a resin bed, the control valve assembly comprising:
a valve including a hard-water inlet port, an outlet port, and a drain port;
a seal assembly disposed within an elongated bore of the valve and defining one or more internal ports at spaced apart locations;
a piston slidably mounted in the elongated bore, the piston having recesses formed at spaced apart locations that create annular flow paths around the piston when aligned with the one or more internal ports;
a sump including:
a removable filter configured to be installed on the sump in either a first orientation or a second orientation;
a removable brine injector configured to be installed on the sump in either a first orifice or a second orifice; and
a removable plug configured to be installed on the sump in either the first orifice or the second orifice.

12. The control valve assembly of claim 11, wherein when the removable filter is in the first orientation, the removable brine injector is in the first orifice, and the removable plug is in the second orifice, the control valve assembly provides a first regeneration flow path where regenerant flows around a distributor tube in through a top of the resin bed and out through the distributor tube from a bottom of the resin bed and when the removable filter is in the second orientation, the removable brine injector is in the second orifice, and the removable plug is in the first orifice, the control valve assembly provides a second regeneration flow path where regenerant flows through the distributor tube to the bottom of the resin bed and out around the distributor tube from the top of the resin bed.

13. The control valve assembly of claim 11, wherein the removable filter comprises a removable lug section and a removable screen section formed as a single piece.

14. The control valve assembly of claim 11, wherein the removable filter comprises a removable lug section and a removable screen section, the removable lug section being configured to be installed on the sump in a third orifice when the removable filter is in the first orientation and in a fourth orifice when the removable filter is in the second orientation.

15. The control valve assembly of claim 11, further comprising a drive mechanism operably coupled to the piston and a controller operably coupled to the drive mechanism, wherein during regular operation, the controller positions the piston to selectively allow liquid to flow from the hard-water inlet port, through the resin bed, and to the outlet port through the annular flow paths between the piston and the seal assembly.

16. The control valve assembly of claim 15, wherein the drive mechanism is an electric motor.

17. The control valve assembly of claim 11, wherein the regenerant is a brine solution.

18. A regeneration flow path direction control assembly comprising:
a control valve operably coupled to a water softening system having a resin bed and a distributor tube;
a removable filter configured to be installed on the control valve in either a first orientation or a second orientation;
a removable brine injector configured to be installed on the control valve in either a first orifice or a second orifice; and
a removable plug configured to be installed on the control valve in either the first orifice or the second orifice;
wherein the control valve creates a first regeneration flow path where regenerant flows around a distributor tube in through a top of the resin bed and out through the distributor tube from a bottom of the resin bed when the removable filter is in the first orientation, the removable brine injector is installed in the first orifice, and the removable plug is installed in the second orifice, and
wherein the control valve creates a second regeneration flow path where regenerant flows through the distributor tube to the bottom of the resin bed and out around the distributor tube from the top of the resin bed when the removable filter is configured in the second orientation, the removable brine injector is installed in the second orifice, and the removable plug is installed in the first orifice.

19. The regeneration flow path direction control assembly of claim 18, wherein the removable filter comprises a removable lug section and a removable screen section formed as a single piece.

20. The regeneration flow path direction control assembly of claim 18, wherein the removable filter comprises a removable lug section and a removable screen section, the removable lug section being configured to be installed on the sump in a third orifice when the removable filter is in the first orientation and in a fourth orifice when the removable filter is in the second orientation.
